(19) United States
(12) Patent Application Publication
(10) Pub. No.: US 2010/0260438 A1
(43) Pub. Date: Oct. 14, 2010

(54) Image processing apparatus and medium storing image processing program

(75) Inventors: Takatoshi MORIKAWA, Tokyo (JP); Mari SUGIHARA, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/752,546

(22) Filed: Apr. 1, 2010

(30) Foreign Application Priority Data
Apr. 8, 2009 (JP) 2009-093998

(51) Int. Cl. G06K 9/36

(52) U.S. Cl. 382/284

(57) ABSTRACT

There are provided an image processing apparatus and a storage medium storing an image processing program capable of easily refurbishing a photographed image by performing retouching on the image regardless of a type or a size of a retouch target included in the photographed image, by being provided with an object database storing a plurality of objects which are capable of being overlapped as to cover a part of the photographed image and include an image and a three-dimensional object model of material body forming a spontaneous boundary with the photographed image, a retrieving unit retrieving at least one of the objects from the object database based on a characteristic of the scene of the photographed image, and a composition unit performing a composition by overlapping an image representing at least one of the objects being selected with the photographed image as to cover a part of the photographed image.

### CROSS REFERENCE TO RELATED APPLICATION

This application is based upon and claims the benefit of priority from Japanese Patent Application No. 2009-093998, filed on Apr. 8, 2009, the entire contents of which are incorporated herein by reference.

### BACKGROUND

1. Field

The present application relates to an image processing apparatus and a storage medium storing an image processing program.

2. Description of the Related Art

When an undesired subject is captured in an image photographed by a digital camera and the like, there has been conventionally performed manual retouching with the use of a function (copy brush function or the like) with which a portion, in the photographed image, in which the undesired subject is captured is filled, by using a pattern representing color and texture of a designated place, for instance.

Further, as a similar retouching technique, there have been proposed a technique in which an unnecessary portion such as a portion in which an undesired subject is captured is removed from a photographed image and color and texture of a surrounding of the unnecessary portion are applied to the removed portion, to thereby complement the portion (refer to Patent Document 1: Japanese Unexamined Patent Application Publication No. H06-65519), a technique in which a portion of a face shadowed by a hat or the like is complemented by using a sample image representing an eye, a nose and the like (refer to Patent Document 2: Japanese Unexamined Patent Application Publication No. 2007-226655), and the like.

Further, there has also been proposed a technique in which an image having a portion that fits naturally to a boundary between an unnecessary portion and a portion other than the unnecessary portion included in a retouch target image is found out from a huge number of sample images, and an image of the unnecessary portion is replaced with a part of the found image (refer to Non-Patent Document 1: “Scene Completion Using Millions of photographs”, James Hays, Alexei A. Efros. ACM SIGGRAPH 2007 conference proceedings).

In the manual retouching, although fine retouching can be performed, the operation itself is very complicated, and moreover, a result of retouching operation is largely dependent on knowledge, experience and skill of a person who performs the operation.

Therefore, an automation of the retouching operation is desired.

In the techniques in Patent Documents 1 and 2, the retouching operation can be automated to some degree. However, it becomes difficult to deal with the automation in the technique in Patent Document 1 when a size of a retouching portion becomes large, and in the technique in Patent Document 2, an operation target is limited to a case where the retouching is performed on a portion of a face that is not captured.

Meanwhile, in the technique in Non-Patent Document 1, it is possible to remove a wide area and embed an appropriate portion of another image into the removed area. However, a database storing a huge number of images is required to find a candidate suitable for the embedding. Further, a large processing capability is required not only for a process to find out a candidate image from the database but also for a boundary process to eliminate a factitious boundary between the embedded image and the original image.

As described above, the conventional technique to perform retouching on a photographed image using a portion in the photographed image or another image to refurbish the photographed image has a limitation in a range and a target on which the retouching can be performed, and requires a huge amount of image information resources and processing time for the retouching process, so that the technique was not always easy to use for ordinary users.

### SUMMARY

A proposition of the present application is to provide an image processing apparatus and a storage medium storing an image processing program capable of easily refurbishing a photographed image by performing retouching on the image, regardless of a type or a size of a retouch target included in the photographed image.

The aforementioned proposition can be achieved by the image processing apparatus and the storage medium storing the image processing program disclosed hereinbelow.

The image processing apparatus of a first aspect of embodiment includes an object database accumulating a plurality of objects which are capable of being overlapped to be disposed as to cover a part of a photographed image and include an image and a three-dimensional object model of material body forming a spontaneous boundary with an image representing a scene represented by the photographed image, a retrieving unit retrieving at least one of the objects from the object database based on a characteristic of the scene represented by the photographed image, and a composition unit performing a composition by overlapping an image representing at least one of the objects being selected with the photographed image as to cover a part of the photographed image.

Further, the storage medium storing the image processing program of a second aspect of embodiment is the storage medium storing the image processing program being read and executed by a computer which can access to an object database storing a plurality of objects which are capable of being overlapped to be disposed as to cover a part of a photographed image and include an image and a three-dimensional object model of material body forming a spontaneous boundary with an image representing a scene represented by the photographed image, in which the image processing program includes a retrieving step retrieving at least one of the objects from the object database based on a characteristic of the scene represented by the photographed image, and a composition step performing a composition by overlapping an image representing at least one of the objects being selected with the photographed image as to cover a part of the photographed image.

### BRIEF DESCRIPTION OF THE DRAWINGS

FIG. 1 is a view illustrating an embodiment of an image processing apparatus.

FIG. 2 is a flow chart illustrating a refurbish operation of a photographed image.

FIG. 3 are views for explaining a process to refurbish a photographed image.

FIG. 4 is a view illustrating another embodiment of the image processing apparatus.

FIG. 5 is a view illustrating another embodiment of the image processing apparatus.

FIG. 6 are views for explaining a process to refurbish a photographed image.

### DETAILED DESCRIPTION OF THE EMBODIMENTS

Hereinafter, embodiments of the present invention will be described in detail based on the drawings.

### Embodiment 1

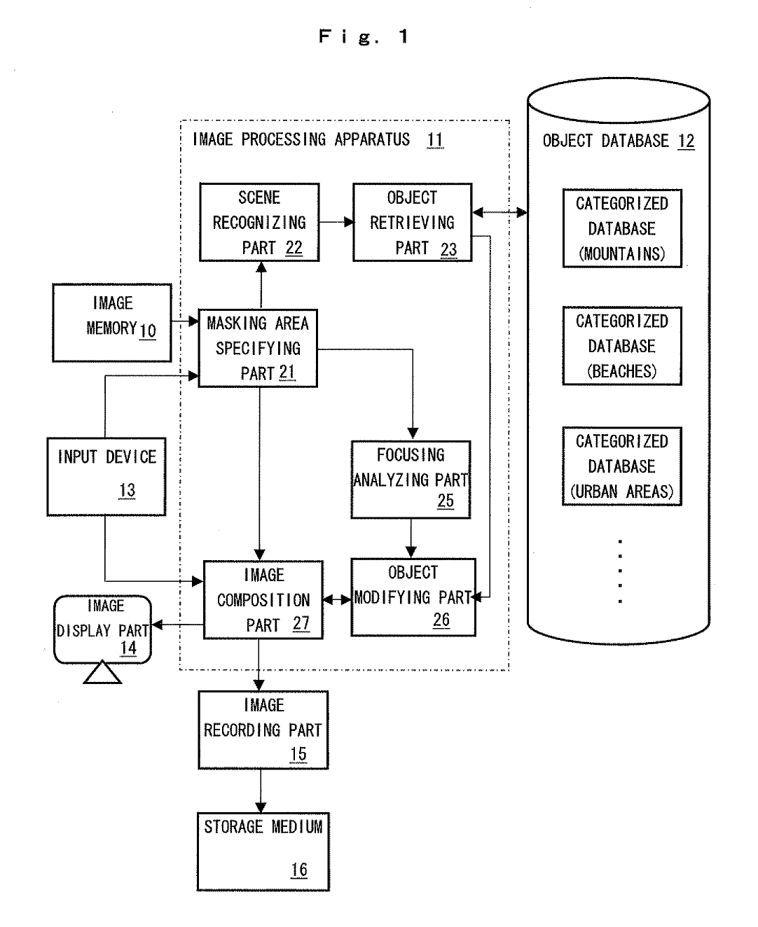

FIG. 1 illustrates one embodiment of an image processing apparatus.

An image processing apparatus 11 illustrated in FIG. 1 performs retouching on a photographed image stored in an image memory 10 in a manner to be described later using an object (which will be described later) registered in an object database 12, in accordance with an instruction from a user input via an input device 13. An image refurbished through the retouching process performed by the image processing apparatus 11 (hereinafter, referred to as refurbished image) is provided to the user via an image display part 14, and is also recorded in a storage medium 16 such as a memory card via an image recording part 15.

The object database 12 is provided with a categorized database (DB) for each of typical photographed scenes such as, for instance, mountains, beaches, and urban areas. And in each of the categorized databases, an image or a three-dimensional object model of material body which is often included in a picture composition of each photographed scene is registered. For instance, in a categorized database corresponding to a photographed scene in which a mountain is a main subject, images or three-dimensional object models representing material bodies such as trees and rocks in great variety, and images or three-dimensional object models representing topography of mountain, cliff and the like, can be registered.

The image registered in these categorized databases is, for instance, an image obtained by trimming, from an image obtained by photographing a tree, only a portion of the tree, and does not include a portion being a background. An image whose boundary and a contour of a material body captured in the image match as above, and a three-dimensional object model of the material body are both called objects in the present specification.

Hereinafter, description will be made specifically on a method of performing a masking process on a part of a photographed image by overlapping an object with the part of the photographed image to perform composition, and outputting a refurbished image after the process using the image processing apparatus illustrated in FIG. 1.

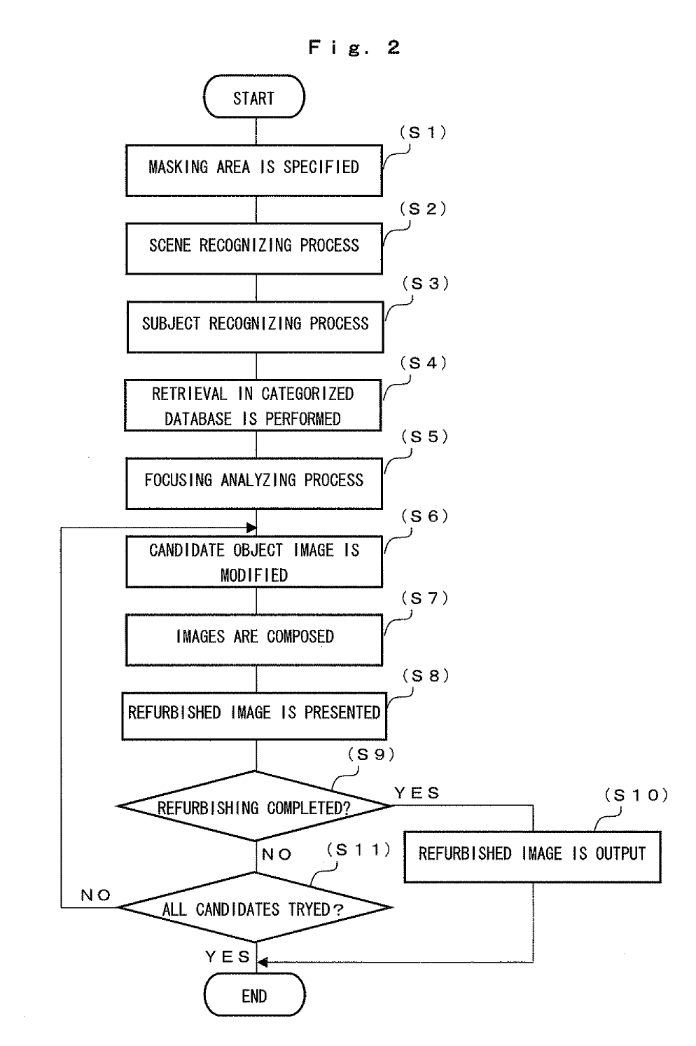

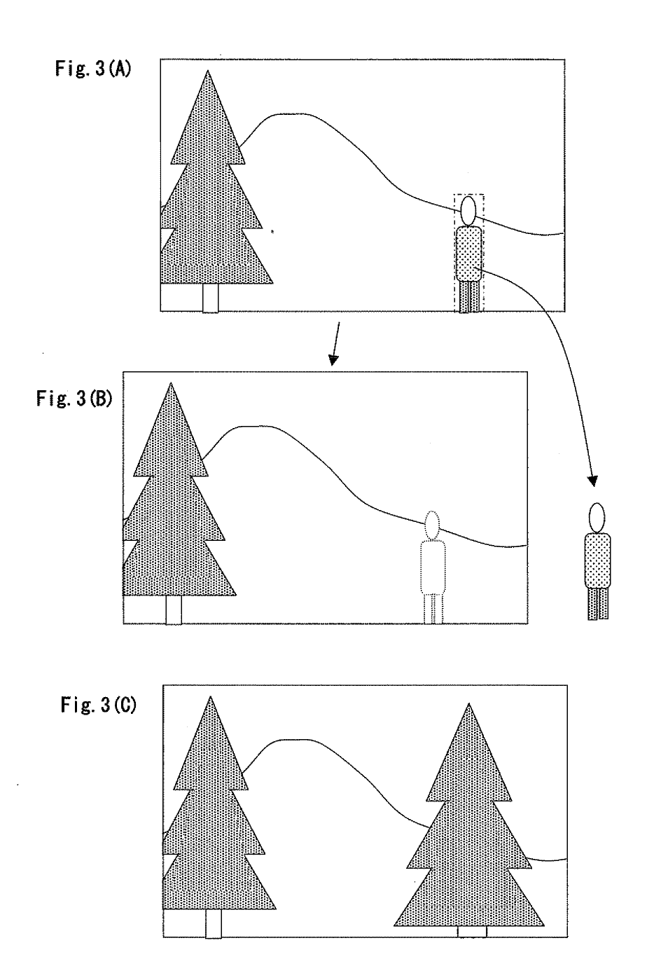

FIG. 2 illustrates a flow chart showing a refurbish operation of a photographed image. Further, FIGS. 3(A), 3(B), and 3(C) illustrate views for explaining a process to refurbish a photographed image.

In the image processing apparatus 11 illustrated in FIG. 1, a masking area determining part 21 displays a photographed image held in the image memory 10 on the image display part 14, prompts a user to designate an area to be masked, and specifies the area designated by an instruction from the user input via the input device 13 as a masking area, for instance (step S1 in FIG. 2). For instance, there is a case that, as illustrated in FIG. 3(A), an unexpected person (indicated by being surrounded by a dotted line in FIG. 3(A)) is captured in a photographed image in which scenery is photographed. In such a case, the user can designate the person surrounded by the dotted line, as a target to be masked, via the input device 13. In accordance with such an instruction, the masking area determining part 21 performs a process to extract a contour of the person, for instance, and the contour and inside the contour are specified as a masking area.

An image of the masking area specified as above and a photographed image other than the masking area are separated as illustrated in FIG. 3(B), and image analysis using a pattern matching technique or the like is performed on each of the images, by a scene recognizing part 22.

In the photographed image from which the masking area is removed, a scene represented by the photographed image is recognized, through a scene recognizing process, based on a shape, disposition and the like of a main subject (mountain scenery and a tree on the left side, in an example illustrated in FIGS. 3(A) and 3(B)) (step S2). At this time, by analyzing the photographed image from which the masking area is removed to obtain information indicating a characteristic of color and a characteristic of texture with the use of the scene recognizing part 22, it is possible to obtain detailed information, regarding the scene represented by the photographed image, including a season in which the image is photographed, a characteristic of the main subject and the like. In the photographed image illustrated in FIG. 3(B) from which the masking area is removed, the removed portion is indicated by being surrounded by a broken line.

Further, through an image analyzing process with respect to the image separated as the masking area, the scene recognizing part 22 can recognize a material body represented by the image of the masking area, and estimate, based on the result of recognizing, a rough size of the recognized material body (person, in the example of FIG. 3), for instance (step S3 in FIG. 2).

Based on thus obtained result of recognition performed by the scene recognizing part 22, an object having a characteristic similar to the characteristic of the photographed image is retrieved from the corresponding categorized database in the object database 12 (step S4 in FIG. 2). At this time, it is also possible to design such that the object retrieving part 23 performs retrieval by limiting, while referring to a size of the material body represented by the image of the masking area obtained in the aforementioned step S3, the object to the one that represents a material body having substantially the same size as the material body represented by the image of the masking area. The object retrieved by the object retrieving part 23 is given, as a candidate object used for retouching the photographed image, to a later-described composition process with the photographed image.

Further, a focusing analyzing part 25 illustrated in FIG. 1 receives the image of the masking area specified as described above from the masking area determining part 21, and analyzes an edge width, an intensity of contrast and the like contained in the image of the masking area, to thereby evaluate quality of blur of the image (step S5 in FIG. 2).

Based on the result of evaluation, a modifying process employing a mean filter and the like, for instance, is performed by an object modifying part 26 on the image representing the candidate object given by the object retrieving part 23 (step S6 in FIG. 2), to thereby obtain a candidate object image whose quality of blur is approximated to that of the aforementioned image of the masking area. Note that when the candidate object is a three-dimensional object model, an image of material body seen from a desired direction is generated in accordance with an instruction from the user and the aforementioned modifying process is performed by using the image as the candidate object image, with the use of the object modifying part 26, for instance.

Thus modified candidate object image is given to an image composition part 27, and the image composition part 27 performs composition by overlapping the candidate object image with the photographed image so as to cover the masking area specified by the aforementioned masking area determining part 21 (step S7 in FIG. 2), to thereby obtain a refurbished image as illustrated in FIG. 3(C) in which an image of the unexpected person captured in the photographed image is concealed to be masked by the candidate object image (image of tree, for instance).

The candidate object image retrieved from the object database 12 and modified by the object modifying part 26 as described above can form a spontaneous boundary with the original photographed image only by being directly overlapped with the original photographed image. Therefore, since a process to naturally disguise the boundary which has to be performed when a portion of another image is extracted and pasted on the photographed image can be omitted, the retouching process for masking an unexpected person and the like captured in the photographed image can be realized at very high speed.

Further, regarding the object being the image registered in the object database 12, the contour of the material body represented by the image and the boundary of the image match and no background is provided as described above, so that there is no need to consider a combination of background with various colors and brightness and the material body assumed in the photographed image. So it is sufficient if one object is prepared for each material body. Therefore, for instance, a capacity of the object database can be reduced to the extent that the database can be stored in a CD-ROM or the like capable of being read by a home personal computer, which enables to allow the user to enjoy retouching of the photographed image with ease at home and the like.

Note that the respective elements included in the image processing apparatus 11 illustrated in FIG. 1 can also be realized by reading a program attached to an image input device such as a digital camera into a home personal computer.

Further, the refurbished image generated through the aforementioned composition process is presented to the user via the image display part 14 (step S8 in FIG. 2). When a response, with respect to the presented image, indicating that the user likes the refurbished image is made by the user via the input device 13, the image composition part 27 judges to complete the refurbish process (affirmative judgment in step S9), and records the refurbished image obtained through the composition process in step S7 in the storage medium 16 via the image recording part 15 (step S10). At this time, for example, the image recording part 15 can record the refurbished image in which is composed as described above, separately from the original photographed image. Further, as a layer image in photo retouching software, the object image may be recorded additionally with the original photographed image. Further, when the refurbished image is recorded separately from the original photographed image, association information with the original photographed image, information indicating that the refurbished image is a retouched image, and information regarding the composed object can also be added to the refurbished image.

Meanwhile, when a negative response with respect to the presented refurbished image is made by the user (negative judgment in step S9), the image composition part 27 judges whether or not the composition with respect to all the candidate objects is tried (step S11).

When an unprocessed candidate object remains (negative judgment in step S11), the image composition part 27 and the object modifying part 26 perform the modifying process and the composition process on another candidate object (steps S6, S7), and a new refurbished image is presented to the user via the image display part 14 so that it is provided for the judgment of the user again.

When a refurbished image affirmed by the user is not generated even if the aforementioned step S6 to step S11 are repeated, the process can be terminated at a time point when the composition process with respect to all the candidate objects is completed, or candidate objects can be retrieved again from the another start point.

Note that the aforementioned object composition process may be repeatedly conducted to compose an appropriate object on each of a plurality of masking areas.

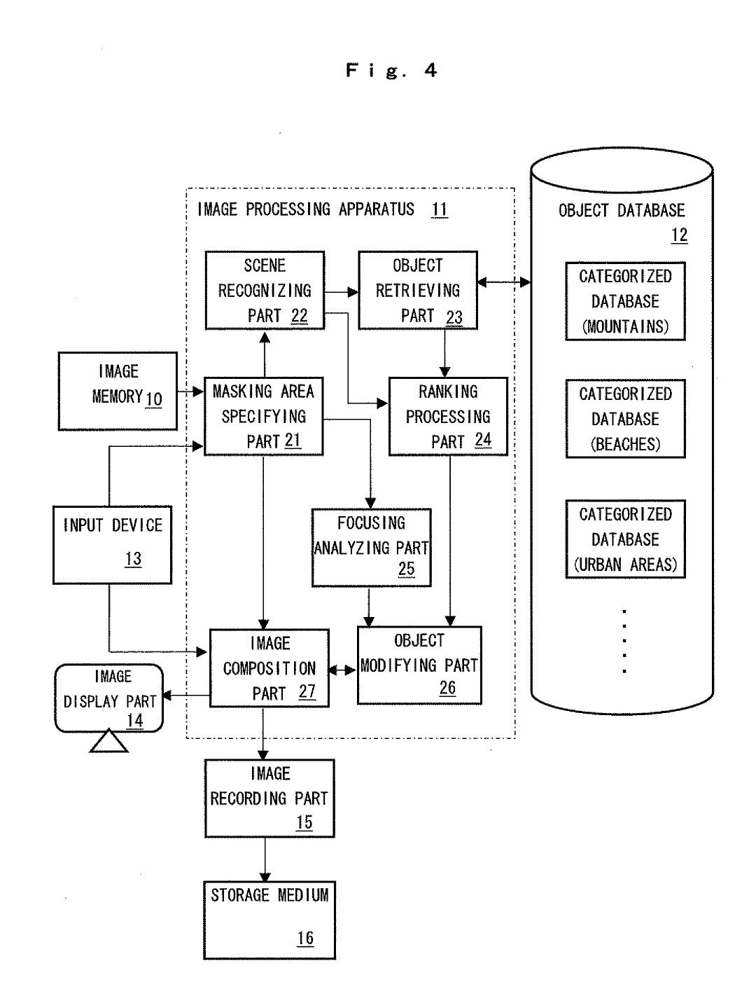

Further, as illustrated in FIG. 4, the image processing apparatus may also be structured by including a ranking processing part 24 that performs ranking of respective candidate objects retrieved from the object database 12.

The ranking processing part 24 performs a process to determine each similarity between each of the candidate objects received from the object retrieving part 23 and, for instance, at least one subject contained in the original photographed image, and to set the highest similarity as a fit index indicating a degree of fit of the candidate object with respect to the photographed image. For the process to calculate the similarity between the candidate object and the subject contained in the original photographed image, a characteristic amount of the main subject image obtained as the recognition result in the scene recognizing part 22 and the like can be used, for instance. Further, the ranking processing part 24 can perform ranking of the respective candidate objects based on the fit index and provide the ranking so that the object modifying part 26 and the image composition part 27 can perform processes in accordance with the ranking.

For example, in the example illustrated in FIG. 3, it is assumed that candidate objects representing various types of trees are retrieved from the categorized database corresponding to mountain scenery. When similarity between these candidate objects and an image of tree captured on the left side of a screen in the example of the images illustrated in FIG. 3 is determined and the ranking is performed based on the similarity, it is possible to give a high rank to the candidate object representing a tree having a characteristic close to the characteristic of the tree captured in the photographed image.

Accordingly, since it is possible to preferentially generate and present a refurbished image that is highly likely to be affirmed by the user, the time required for the refurbish process of the photographed image can be reduced as a whole.

As described above, according to the image processing apparatus illustrated in FIG. 1, a process to mask an unnecessary portion of a photographed image obtained by a digital camera and the like, by covering the portion with an image representing another material body that fits a scene, can be realized at very high speed.

Further, it is also possible that in addition to the process to evaluate the quality of blur of the image of the masking area, a process to extract additional characteristics including color and brightness of the image of the masking area is performed by the focusing analyzing part 25, and the extracted characteristic is utilized for the modifying process of the candidate object image performed by the object modifying part 26.

Furthermore, it is also possible to automatically specify the masking area using a scene recognizing technique.

For instance, when the scene recognizing process is performed on the photographed image, it is possible to detect an image of material body (a person, a license plate of a car or the like, for example) designated by the user via the input device 13 using a pattern matching technique or the like, and to specify a portion of the detected image as a masking area.

### Embodiment 2

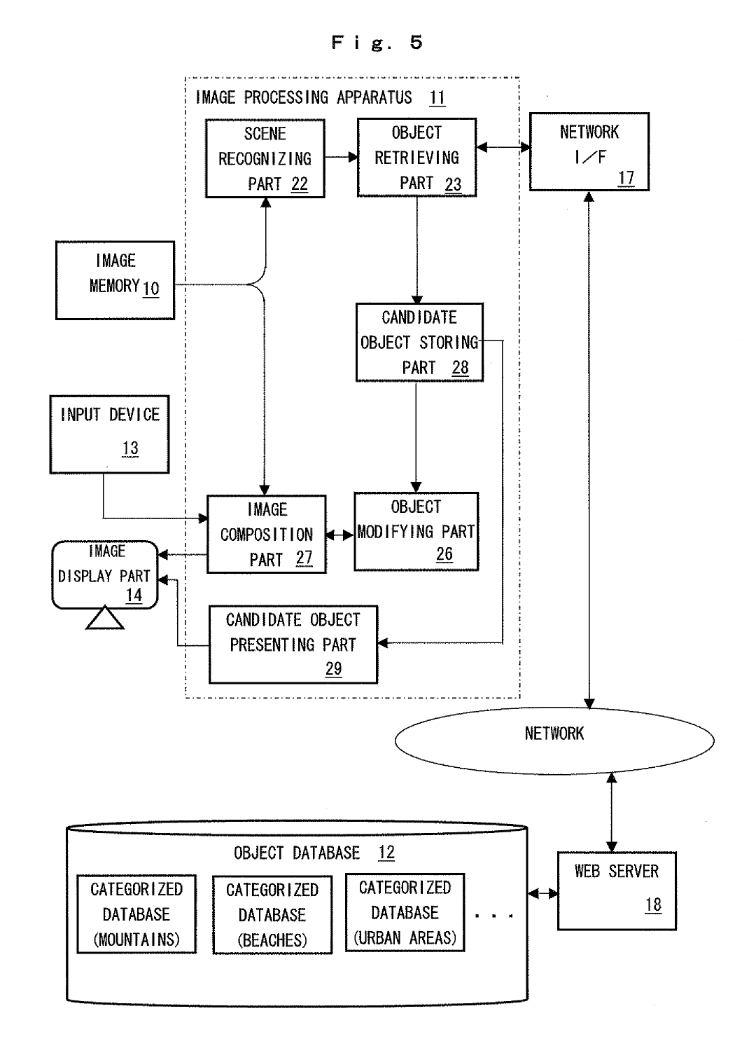

FIG. 5 illustrates another embodiment of the image processing apparatus.

Note that the components illustrated in FIG. 5 being the same components illustrated in FIG. 1 are denoted by the same reference numerals, and explanation thereof will be omitted.

The object database 12 illustrated in FIG. 5 is provided on a web server 18 managed by a manufacturer of a digital camera, for instance, and the image processing apparatus 11 performs retrieval in the object database 12 via a network interface (I/F) 17 and a network.

With a structure as described above in which the object database 12 is provided on the web server 18 managed by the manufacturer, it is possible to prepare a large variety of objects with respect to larger types of scenes.

Hereinafter, explanation will be made on a method of performing composition by disposing an object retrieved from the object database 12 prepared on the web server 18 at a desired position on a photographed image, regardless of whether or not there is a portion to be masked in the photographed image.

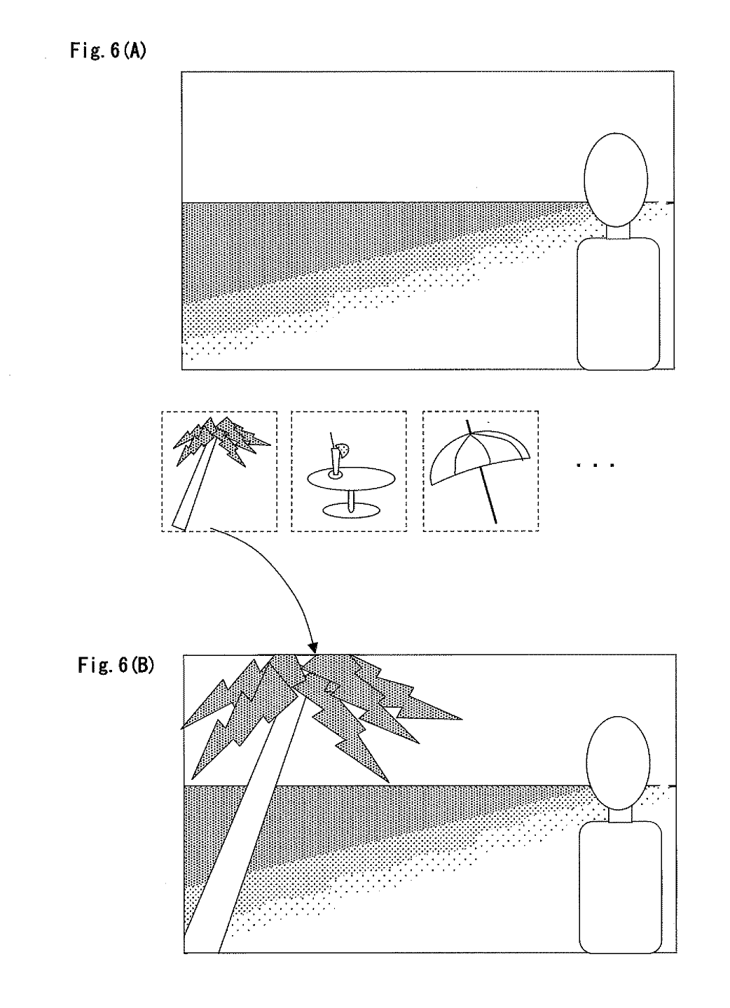

For example, when a photographed image as illustrated in FIG. 6(A) in which a main subject (person on the right side, for instance) and a background are captured is input to the image memory 10, the scene recognizing part 22 performs the scene recognizing process on the photographed image, to thereby recognize that the photographed image is an image in which the person is photographed with a background of beach scenery.

When there is no portion to be masked in the photographed image as above, the retrieval process is performed by the object retrieving part 23 based on the result of scene recognition, and candidate objects are retrieved from a categorized database, corresponding to the result of recognition (beach), of the object database 12 provided on the web server 18. At this time, it is also possible to receive a designation of keyword from the user via the input device 13, and to narrow down the candidate objects using the keyword.

The candidate objects retrieved by the object retrieving part 23 are once held in a candidate object storing part 28, and a candidate object presenting part 29 displays images representing the retrieved respective candidate objects together with the retouch target photographed image on the image display part 14 to present the images to the user, as illustrated in FIG. 6, for instance.

For example, as illustrated in FIG. 6(A), information indicating the candidate object designated through the operation of the input device 13 by the user among the candidate objects presented via the image display part 14 (candidate object representing “palm tree” is designated, for instance) is given to the object modifying part 26 via the image composition part 27.

The object modifying part 26 performs modification of size and color of an image of the candidate object designated by the information given from the image composition part 27, and then gives the modified candidate object image to the image composition part 27 to provide the image for the composition process with the photographed image. At this time, it is possible to modify the size of the candidate object image using, for example, information on the result of recognition regarding the main subject obtained by the scene recognizing part 22 (“person”, for instance) and a material body represented by the selected candidate object (“palm tree”, for instance). Further, it is also possible to perform color coordination of the candidate object image based on the color of the main subject. Furthermore, it is also possible to modify the size and the color of the candidate object in accordance with an instruction input by the user via the input device 13.

By composing thus modified candidate object image at a designated position on the photographed image in accordance with an instruction from the user, it is possible to generate a refurbished image as illustrated in FIG. 6(B) having a taste different from that of the original photographed image.

With the use of the image processing apparatus and the storage medium storing the image processing program structured as above, by overlapping an image representing an object that forms a spontaneous boundary with the original photographed image, it is possible to omit a process to eliminate a factitious boundary between the retouched portion and the other portion in the original photographed image.

Accordingly, a huge amount of image resources and a huge amount of processing cost which have been required in the conventional technique for eliminating the factitious boundary become unnecessary, which enables to easily realize the operation to retouch and refurbish the photographed image.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. An image processing apparatus, comprising:
an object database storing a plurality of objects which are capable of being overlapped to be disposed as to cover a part of a photographed image and include an image and a three-dimensional object model of material body forming a spontaneous boundary with an image representing a scene represented by the photographed image;
a retrieving unit retrieving at least one of the objects from the object database based on a characteristic of the scene represented by the photographed image; and
a composition unit performing a composition by overlapping an image representing at least one of the objects being retrieved with the photographed image to as cover a part of the photographed image.

2. The image processing apparatus according to claim 1, wherein:
the object database is structured to have a categorized database which categorizes and stores at least one of the objects for each of a plurality of scene types which are assumed to be represented by the photographed image; and
the retrieving unit comprises a distinguishing unit distinguishing the scene types represented by the photographed image, and performs retrieval of at least one of the objects from the categorized database corresponding to the scene types being distinguished.

3. The image processing apparatus according to claim 1, wherein
the composition unit comprises:
a similarity calculating unit calculating a similarity between an image representing each of the objects retrieved by the retrieving unit and an image representing at least one material body included in the scene represented by the photographed image; and
an object determining unit determining an object to be overlapped with the photographed image based on a magnitude of the similarity calculated for each of the objects.

4. The image processing apparatus according to claim 1, further comprising:
an area specifying unit specifying an area to be masked by overlapping as to cover the image representing at least one of the objects by the composition unit;
a material recognition unit analyzing an image of a masking area specified by the area specifying unit to recognize a masking target material body represented by the image of the masking area; and
a condition adding unit adding a condition indicated by property information including a size corresponding to the masking target material body being recognized, to a condition with which the retrieving unit retrieves the objects.

5. The image processing apparatus according to claim 1, further comprising:
an area specifying unit specifying an area to be masked by overlapping as to cover the image representing at least one of the objects by the composition unit; and
a focusing evaluating unit analyzing an image of a masking area specified by the area specifying unit to evaluate a focusing of an image of a masking target material body represented by the image of the masking area, wherein
the composition unit comprises an object modifying unit modifying the image representing at least one of the objects as to approximate focusing of the image to the focusing of the image of the masking target material body when overlapping the image representing at least one of the objects with the photographed image.

6. A non-transitory storage medium storing an image processing program being read and executed by a computer which can access to an object database storing a plurality of objects which are capable of being overlapped to be disposed as to cover a part of a photographed image and include an image and a three-dimensional object model of material body forming a spontaneous boundary with an image representing a scene represented by the photographed image, wherein
the image processing program comprises:
a retrieving step retrieving at least one of the objects from the object database based on a characteristic of the scene represented by the photographed image; and
a composition step performing a composition by overlapping an image representing at least one of the objects being retrieved with the photographed image as to cover a part of the photographed image.
